(19) United States
(12) Patent Application Publication
(10) Pub. No.: US 2012/0085256 A1
(43) Pub. Date: Apr. 12, 2012

(54) SELF-ADJUSTING BLANKET WASHER MECHANISM FOR CYLINDERS IN VARIABLE CUTOFF PRINTING PRESSES

(75) Inventors: Michael T. Woroniak, Rochester, NH (US); Michael R. Lemelin, Madbury, NH (US)

(73) Assignee: Goss International Americas, Inc., Durham, NH (US)

(21) Appl. No.: 12/900,005

(22) Filed: Oct. 7, 2010

(51) Int. Cl. B41F 35/00

(52) U.S. Cl. 101/425; 101/483

(57) ABSTRACT

A blanket washing apparatus for washing printing blankets of various circumferences on a blanket cylinder in a variable cutoff printing press is provided. The blanket washing apparatus includes a washer head, a movable bracket coupled to an axial end of the washer head, the movable bracket including a slidable portion to vary a position of the washer head based on the circumference of the printing blanket on the blanket cylinder. The blanket washing apparatus also includes a guide plate for guiding the movable bracket to maintain a prescribed gap between the washer head and the printing blanket on the blanket cylinder as the slidable portion of the movable bracket slides. A variable cutoff printing press and a method of adjusting a position of a blanket washing apparatus during a cutoff change in a printing unit of a printing press are also provided.

The present invention relates generally to printing presses and more particularly to washer mechanisms for printing blankets in printing presses.

### BACKGROUND OF INVENTION

Blanket washers are used in lithographic printing presses to remove ink, paper lint and other debris that builds up over time on the surface of offset lithographic blankets. Blanket washers are securely supported so a prescribed gap is formed between a cleaning element of the blanket washer and a surface of the lithographic blanket. The gap prevents contact between the cleaning element and the blanket surface while the printing press is printing, but the gap is reduced to zero by various mechanical mechanisms (e.g., inflatable air bladder, activation of pneumatic cylinders) to clean the blanket surface with the cleaning element.

Blanket washers are commonly mounted to the press frames via a fixed bracket assembly. The fixed brackets may provide a small amount of adjustability to achieve the prescribed gap upon initial setup, but are designed to support the cleaning element in position for cleaning only blankets of one diameter. During a cutoff change, when a blanket cylinder is replaced with a new blanket cylinder having a smaller or larger diameter, the blanket washer is adjusted manually in order to be able to clean the new blanket cylinder.

### BRIEF SUMMARY OF THE INVENTION

A blanket washing apparatus for washing printing blankets of various circumferences on a blanket cylinder in a variable cutoff printing press is provided. The blanket washing apparatus includes a washer head, a movable bracket coupled to an axial end of the washer head, the movable bracket including a slidable portion to vary a position of the washer head based on the circumference of the printing blanket on the blanket cylinder. The blanket washing apparatus also includes a guide plate for guiding the movable bracket to maintain a prescribed gap between the washer head and the printing blanket on the blanket cylinder as the slidable portion of the movable bracket slides.

A variable cutoff printing press is also provided that includes a blanket cylinder, a blanket cylinder support supporting the blanket cylinder and a a blanket washing apparatus coupled to the blanket cylinder support. The blanket washing apparatus includes a washer head for washing the blanket cylinder and an adjusting and supporting apparatus for moving the washer head to maintain a prescribed gap between the washer head and the blanket cylinder for a plurality of different diameters of the blanket cylinder.

A method of adjusting a position of a blanket washing apparatus during a cutoff change in a printing unit of a printing press is also provided. The method includes removing a first printing blanket from a blanket cylinder in the printing unit, the first printing blanket being separated from a washer head of the blanket washing apparatus by a prescribed gap before being removed, adjusting a position of a blanket cylinder support and placing a second printing blanket having a circumference different from the first printing blanket on the blanket cylinder, the adjusting the position of the blanket cylinder support establishing the prescribed gap between the second printing blanket and the washer head.

### BRIEF DESCRIPTION OF THE DRAWINGS

The present invention is described below by reference to the following drawings, in which:

FIG. 1 schematically shows a printing unit according to an embodiment of the present invention;

FIG. 2 schematically shows a perspective view of a blanket washing apparatus shown in FIG. 1 according to an embodiment of the present invention;

FIG. 3 schematically shows an adjusting and supporting apparatus of a blanket washing apparatus shown in FIG. 2 according to an embodiment of the present invention after being adjusted to accommodate a printing blanket of a larger circumference than a blanket shown in FIG. 2;

FIG. 4 schematically shows the adjusting and supporting apparatus shown in FIG. 3 after being adjusted to accommodate a printing blanket of a smaller circumference than a blanket shown in. FIG. 2; and

FIG. 5 shows a side view of the blanket washing apparatus shown in FIG. 2 with the adjusting and supporting apparatus omitted for clarity.

### DETAILED DESCRIPTION

The following embodiment of the present invention allows a single blanket washer to be used to clean cylinders of variable diameters.

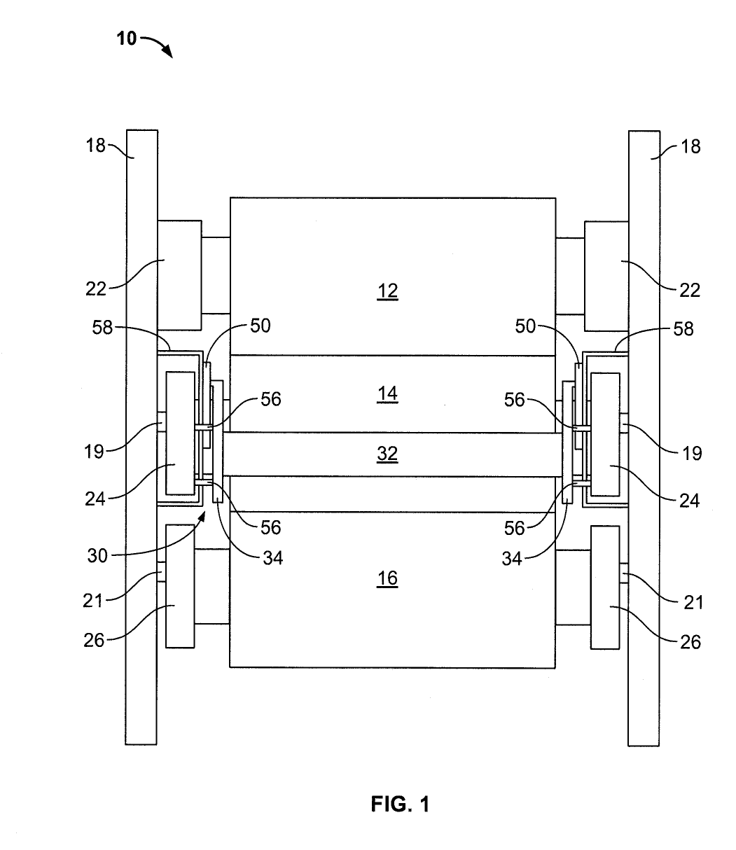

FIG. 1 schematically shows a printing unit 10 according to an embodiment of the present invention. Printing unit 10 includes a plate cylinder 12, a blanket cylinder 14 and an impression cylinder 16 supported in a frame 18 at axial ends thereof by respective supports 22, 24, 26. Alternatively, plate cylinder 12 may be rotatably mounted directly in frame 18 and plate cylinder supports 22 may be omitted. Blanket cylinder supports 24 and impression cylinder supports 26 are pivotably coupled to frame 18 at respective pivots 19, 21 and are adjustable by respective actuators to set the positions of blanket cylinder 14 and impression cylinder 16 for printing according to the diameter of blanket cylinder 14 and plate cylinder 12. In one preferred embodiment, printing unit 10 may include the support apparatus described in commonly owned U.S. patent application Ser. No. 12/836,713, which is hereby incorporated by reference herein, and adjust the position of blanket cylinder 14 and impression cylinder 16 using actuators in the manner described in U.S. patent application Ser. No. 12/836,713. In this embodiment, as described in U.S. patent application Ser. No. 12/836,713, plate cylinder 12 is coupled to frame 18 such that a center axis of plate cylinder 12 during printing is the same regardless of the size of the outer diameter of plate cylinder 12 and blanket cylinder 14, while the positions center axes of blanket cylinder 14 and impression cylinder 16 are moved as a function of the outer diameter of plate cylinder 12 and blanket cylinder 14.

A blanket washing apparatus 30, which is shown schematically in FIG. 1, is also coupled to blanket cylinder supports 24 and frame 18. Blanket washing apparatus 30 includes a washer head 32 that extends along the length of blanket cylinder 14 and movable brackets 34 at the axial ends of washer head 32. Movable brackets 34 are rigidly fastened to blanket cylinder supports 24 by respective fasteners 56. Blanket washing apparatus 30 also includes guide plates 50 on opposite ends thereof rigidly fastened to frame 18 by respective mounts 58. Movable brackets 34 cooperate with guide plates 50 to properly position washer head 32 with respect to blanket cylinder 14 upon the movement of blanket supports 24.

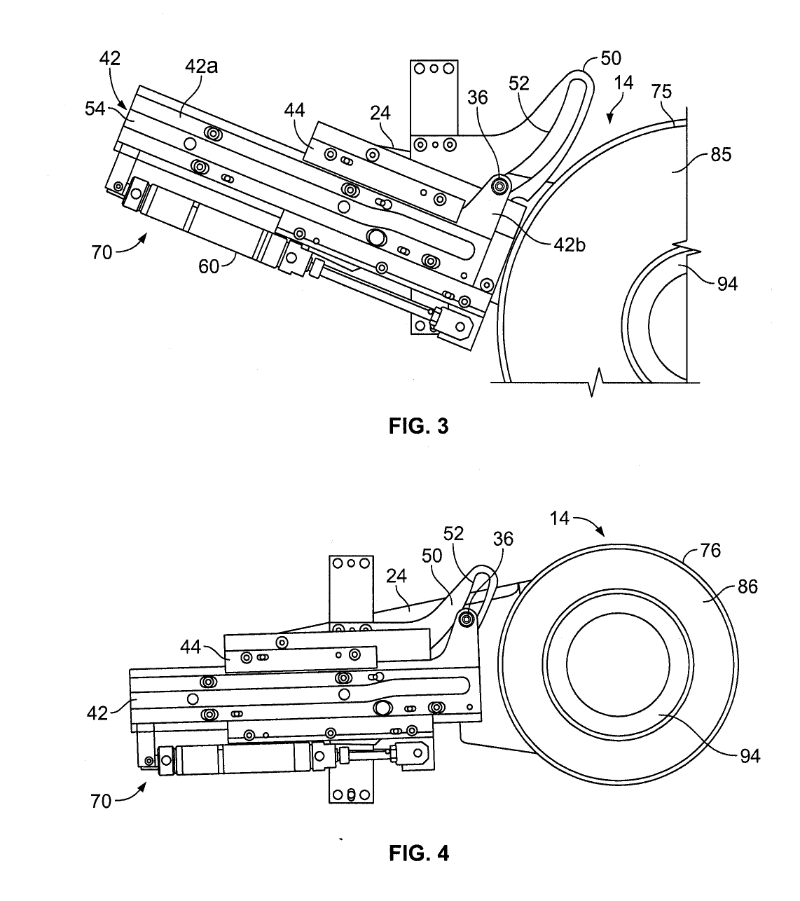

In a preferred embodiment, removable sleeves may be used to vary the diameter of blanket cylinder 14. Blanket cylinders supported by blanket cylinder support 24 may each include a base cylinder or mandrel that is held at both axial ends by the respective supports 24, a sleeve that is slid over the outer surface of the mandrel and a plate or blanket that is wrapped around or slid over the sleeve (i.e., sleeves are similar to the sleeves described in U.S. Pat. No. 5,813,336, which is incorporated by reference herein). For example, during a cutoff change, one blanket cylinder support 24 may beuncoupled from and swung away from blanket cylinder 14 through a hole in frame 18. A blanket cylinder sleeve (e.g., sleeve 85 shown in FIG. 3 or sleeve 86 shown in FIG. 4) mounted on a blanket cylinder mandrel (e.g., blanket cylinder mandrel 94 shown in FIGS. 3, 4) is then slid off of the blanket cylinder mandrel. A blanket mounted on the blanket cylinder sleeve may be removed before or after the blanket cylinder sleeve is slid off of the blanket cylinder mandrel. A different blanket cylinder sleeve having a larger or small outer circumference may then be mounted on the blanket cylinder mandrel. A new blanket may be mounted on the different blanket cylinder sleeve before or after the different blanket cylinder sleeve is slid onto the blanket cylinder mandrel. Removal and replacement of plate cylinders during cutoff changes may occur in the same manner, but with printing plates being mounted on the sleeves instead of blankets. Also, the blanket and plate cylinder mandrels may include holes formed in the outer surfaces thereof so pressurized air may be supplied internally to the mandrels and flow out of the holes to pneumatically mount and remove the sleeves from the respective mandrels. The blanket and plate cylinder mandrels may also include beveled ends on the work side thereof to facilitate the sliding of the sleeves onto the respective mandrel. The holes in the mandrels and the beveled ends, and the elasticity of the sleeves, allow sleeves that have inner circumferences that are slightly smaller than the outer circumferences of the mandrels to be mounted on the mandrels. After a sleeve is slid onto a respective mandrel, the supply of air to the mandrel is stopped and the sleeve is snugly held in place on the mandrel.

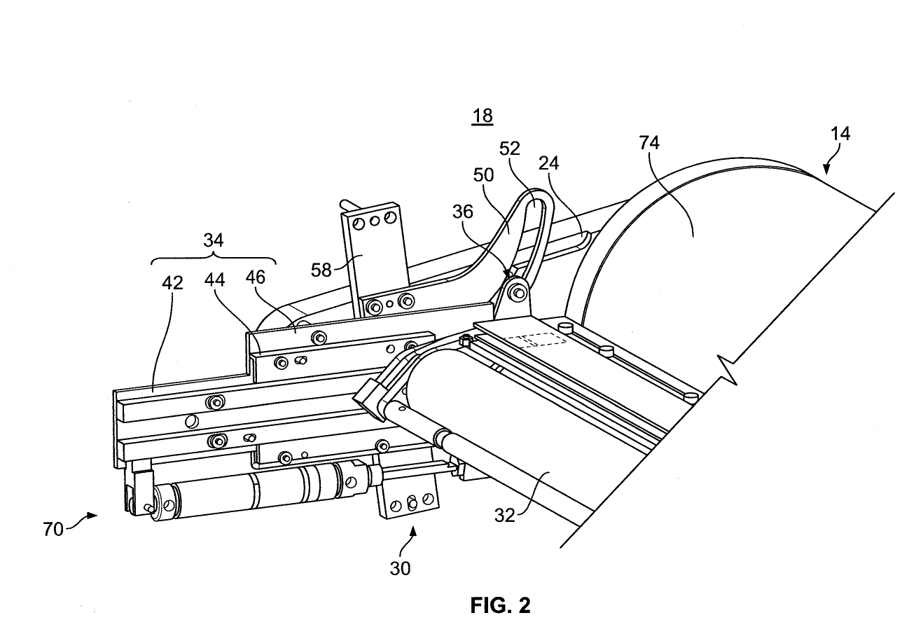

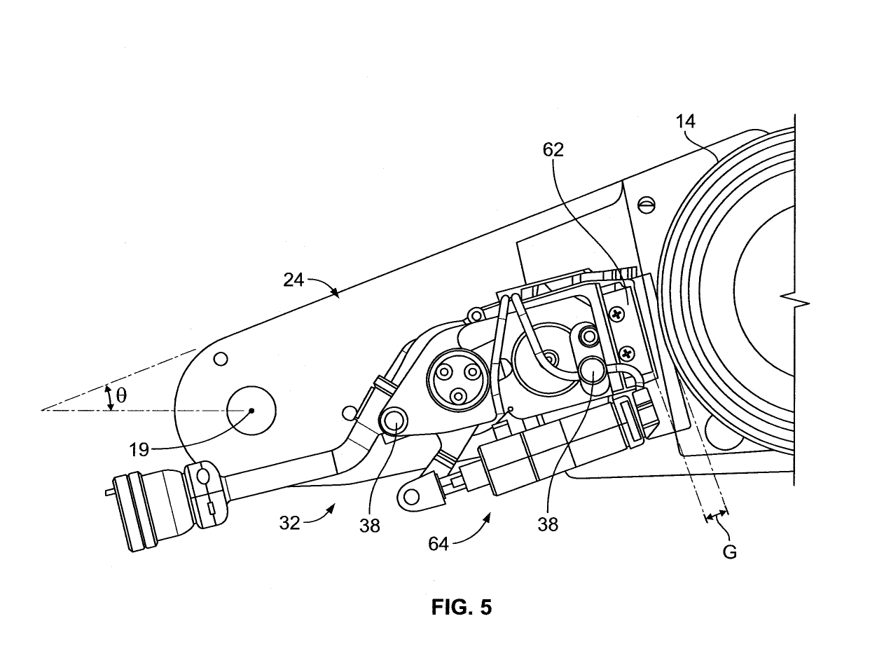

FIG. 2 shows a perspective view of blanket washing apparatus 30 according to an embodiment of the present invention. Blanket washing apparatus 30 is positioned to clean an outer surface of a blanket 74 of blanket cylinder 14, which is pivotably supported by blanket cylinder support 24. Blanket cylinder support 24 is pivotably coupled to frame 18 at pivot 19 (FIGS. 1 and 5) at a pivoting end thereof and rotatably supports blanket cylinder 14 at a blanket supporting end thereof Blanket washing apparatus 30 is slidably coupled to blanket support 24 so that blanket washing apparatus is slidable between the two ends of blanket support 24. Accordingly, blanket washing apparatus 30 includes an adjusting and supporting apparatus 70 that allows a washer head 32 of blanket washing apparatus 30 to self-adjust and maintain a prescribed gap G (FIG. 5) and angular orientation between washer head 32 and the outer surface of blanket cylinder 14 (i.e., an outer surface of blanket 74) during a cutoff change.

Adjusting and supporting apparatus 70 includes two movable brackets 34 at the axial ends of washer head 32 that allow motion toward and away from the center axis of blanket cylinder 14. In this embodiment, movable bracket 34 includes a rail 42, a linear guide 44 and a base plate 46. Rail 42 is constrained by and sliding in linear guide 44, which is mounted to base plate 46. Base plate 46 is rigidly mounted on blanket cylinder support 24. Locators 38 (FIG. 5), which in this embodiment are pins, on opposite ends of washer head 32 are used to fix washer head 32 to rail 42. Each movable bracket 34 has a cam follower 36 included on or coupled to the respective rail 42. To guide cam follower 36 along a predetermined path, adjusting and supporting apparatus 70 includes guide plate 50. Guide plate 50 is rigidly connected to frame 18 by mount 58 and includes a cam profile 52 formed therein. Cam follower 36 extends into cam profile 52 such that as blanket cylinder support 24 is pivoted up and down about pivot 19 cam follower 36 slides along cam profile 52. Cam profile 52 is designed such that there is a unique contact point between cam follower 36 and cam profile 52 for every angle θ (FIG. 5) of blanket cylinder support 24 with respect to horizontal and thus a unique contact point for an infinitely variable number of blanket cylinder diameters within a specified range. For a given blanket cylinder diameter, cam follower 36 contacts cam profile 52 at a point which moves sliding rail 42 into a position that establishes the prescribed gap G (FIG. 5) and the angular orientation between washer head 32 and the outer surface of blanket cylinder 14.

Angle θ (FIG. 5) is varied in accordance with the diameter of blanket cylinder 14 by rotating blanket cylinder support about pivot 19. The rigid connection between base plate 46, linear guide 44 and blanket cylinder support 24 ensures that the angular orientation between washer head 32 and blanket cylinder 14 remains constant and prescribed gap G remains constant regardless of both the diameter of blanket cylinder 14 and angle θ.

Due to the connection between rails 42 and washer head 32, washer head 32 may be slid radially with respect to blanket cylinder 14 in order to maintain the prescribed gap G (FIG. 5) and angular orientation between blanket washer head 32 and the outer surface of blanket cylinder 14, regardless of the diameter of blanket cylinder 14. Gap G and the above described configuration of blanket washing apparatus 30 allow washer head 32 to properly clean blanket cylinders of various diameters.

FIG. 3 shows adjusting and supporting apparatus 70 after being adjusted to accommodate a printing blanket 75 of a larger circumference than blanket 74 shown in FIG. 2. Washer head 32 (FIGS. 1, 2 and 5) has been omitted for clarity. Increasing the size of blanket cylinder 14 with respect to FIG. 2 may be accomplished by removing printing blanket 74 and a sleeve supporting printing blanket 74 from a body or mandrel 94 of blanket cylinder 14 and placing a sleeve 85, which has a larger diameter than the sleeve that supported printing blanket 74, and printing blanket 75, which has a larger circumference than printing blanket 74, on mandrel 94. Before sleeve 85 and blanket 75 are placed on mandrel 94, in order to accommodate the larger printing blanket 75 and properly position blanket cylinder 14 with respect to plate cylinder 12 (FIG. 1), blanket cylinder support 24 has been pivoted downwardly with respect to the position shown in FIG. 2. As blanket cylinder support 24 was pivoted downward by the respective actuator, cam follower 36 slides downward in profile 52 formed in guide plate 50, sliding rail 42 in linear guide 44 away from the supporting end of blanket cylinder support 24 and towards the pivoting end of blanket cylinder support 24.

In this embodiment, sliding rail 42 includes two pieces 42a, 42b. First piece 42a features a milled slot 54 into which locators 38 are inserted. Second piece features cam follower 36. Pieces 42a, 42b are fastened together during normal operation, but can be manually adjusted relative to one another to adjust the relative position between cam follower 36 and blanket washer 32 in case fine turning of prescribed gap G is required. A pneumatic cylinder 60 may be coupled to both rail 42 and base plate 46 to load cam follower 36 against cam profile 52 to prevent undesired vibration of blanket washing apparatus 30 due to clearance between components of adjusting and supporting apparatus 70.

FIG. 4 shows adjusting and supporting apparatus 70 after being adjusted to accommodate a printing blanket 76 of a smaller circumference than blanket 74 shown in FIG. 2. Washer head 32 (FIGS. 1, 2 and 5) has been omitted for clarity. Decreasing the size of blanket cylinder 14 with respect to FIG. 2 may be accomplished by removing printing blanket 74 and the sleeve supporting printing blanket 74 from mandrel 94 of blanket cylinder 14 and placing a sleeve 86, which has a smaller diameter than the sleeve that supported printing blanket 74, and printing blanket 76, which has a smaller circumference than printing blanket 74, on mandrel 94. After sleeve 86 and blanket 76 are placed on mandrel 94, in order to accommodate the smaller printing blanket 76 and properly position blanket cylinder 14 with respect to plate cylinder 12 (FIG. 1), blanket cylinder support 24 has been pivoted upwardly with respect to the position shown in FIG. 2. As blanket cylinder support 24 was pivoted upward by the respective actuator, cam follower 36 slides upward in profile 52 formed in guide plate 50, sliding rail 42 in linear guide 44 toward the supporting end of blanket cylinder support 24 and away from the pivoting end of blanket cylinder support 24.

FIG. 5 shows a side view of blanket washing apparatus 30 with adjusting and supporting apparatus 70 omitted for clarity. Angle θ of blanket cylinder support 24 with respect to horizontal is shown as being a positive value, but can also be a negative value. Washer head 32 includes a cleaning element 62, which in a preferred embodiment includes a cloth, for contacting and cleaning blanket cylinder 14 and fasteners 38 for fastening washer head 32 to rails 42 (FIGS. 2 to 4). An inflatable bladder within washer head 32 may move cleaning element 62 towards blanket cylinder for cleaning to eliminate gap G while brackets 34 (FIGS. 1 to 4) and blanket cylinder supports 24 remain stationary. An actuator 64 may advance the cloth inside cleaning element 62 to clean the surface of blanket cylinder 14.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A blanket washing apparatus for washing printing blankets of various circumferences on a blanket cylinder in a variable cutoff printing press comprising:
a washer head;
a movable bracket coupled to an axial end of the washer head, the movable bracket including a slidable portion to vary a position of the washer head based on the circumference of the printing blanket on the blanket cylinder; and
a guide plate for guiding the movable bracket to maintain a prescribed gap between the washer head and the printing blanket on the blanket cylinder as the slidable portion of the movable bracket slides.

2. The apparatus recited in claim 1 wherein the guide plate guides the movable bracket to maintain an angular orientation between the washer head and the printing blanket on the blanket cylinder as the slidable portion of the movable bracket slides.

3. The apparatus recited in claim 1 wherein the movable bracket includes a first portion coupled to a blanket cylinder support and a second portion coupled to the movable bracket, the first portion being movable with respect to the second portion toward and away from the blanket cylinder.

4. The apparatus recited in claim 3 wherein the first portion includes a cam follower and the guide plate includes a profile, the profile guiding the cam follower to maintain the prescribed gap between the washer head and the printing blanket on the blanket cylinder.

5. The apparatus recited in claim 3 wherein the first portion is a linear guide and the second portion is a rail for sliding in the linear guide.

6. The apparatus recited in claim 1 wherein the movable bracket is coupled to blanket cylinder support supporting the blanket cylinder and the guide plate is coupled to a frame pivotably supporting the blanket cylinder support.

7. The apparatus recited in claim 6 wherein movement of the blanket cylinder support causes the slidable portion of the movable bracket to slide along the guide plate, the guide plate being shaped to maintain the prescribed gap.

8. A variable cutoff printing press comprising:
a blanket cylinder;
a blanket cylinder support supporting the blanket cylinder; and
a blanket washing apparatus coupled to the blanket cylinder support, the blanket washing apparatus including a washer head for washing the blanket cylinder and an adjusting and supporting apparatus for moving the washer head to maintain a prescribed gap between the washer head and the blanket cylinder for a plurality of different diameters of the blanket cylinder.

9. The variable cutoff printing press recited in claim 8 wherein the adjusting and supporting apparatus moves the washer head to maintain an angular orientation between the washer head and the blanket cylinder for a plurality of different diameters of the blanket cylinder.

10. The variable cutoff printing press recited in claim 8 wherein the diameter of the blanket cylinder is varied by replacing a sleeve of the blanket cylinder and a blanket of the blanket cylinder.

11. The variable cutoff printing press recited in claim 8 further comprising a frame pivotably supporting the blanket cylinder support.

12. The variable cutoff printing press recited in claim 11 wherein the adjusting and supporting apparatus includes a movable bracket coupled to an end of the washer head and a guide plate for guiding the movable bracket to maintain the prescribed gap between the washer head and the blanket cylinder for a plurality of different diameters of the blanket cylinder.

13. The variable cutoff printing press recited in claim 12 wherein the guide plate is fastened to the frame and the movable bracket is fastened to the blanket cylinder support.

14. The variable cutoff printing press recited in claim 8 wherein movement of the blanket cylinder support causes the movable bracket to move along the guide plate.

15. A method of adjusting a position of a blanket washing apparatus during a cutoff change in a printing unit of a printing press comprising:
removing a first printing blanket from a blanket cylinder in the printing unit, the first printing blanket being separated from a washer head of the blanket washing apparatus by a prescribed gap before being removed;
adjusting a position of a blanket cylinder support; and
placing a second printing blanket having a circumference different from the first printing blanket on the blanket cylinder, the adjusting the position of the blanket cylinder support establishing the prescribed gap between the second printing blanket and the washer head.

16. The method recited in claim 15 wherein the blanket washing apparatus includes a movable bracket coupled to an end of the washer head and a guide plate for guiding the movable bracket, the adjusting the position of the blanket cylinder support causing the movable bracket to move along the guide and establish the prescribed gap between the second printing blanket and the washer head.
